(19) United States
(12) Patent Application Publication
(10) Pub. No.: US 2009/0164257 A1
(43) Pub. Date: Jun. 25, 2009

(54) SYSTEM AND METHOD FOR TRADING ASSETS AND THEIR DERIVATIVES

(76) Inventors: TERENCE PHILIP RAMSDEN, ST ANNES (GB); NASSER NASSIRI, COURBEVOIE (FR)

Correspondence Address: KENYON & KENYON LLP, ONE BROADWAY, NEW YORK, NY, 10004, US

(21) Appl. No.: 12/339,844

(22) Filed: Dec. 19, 2008

Related U.S. Application Data
(60) Provisional application No. 61/008,421, filed on Dec. 19, 2007.

(51) Int. Cl. G06Q 40/00

(52) U.S. Cl. 705/4

(57) ABSTRACT

A system and method of an instrument conversion machine, where the instrument may include life insurance policies, particularly senior life settlements and their derivatives to provide liquidity and an investment vehicle to holders of life insurance policies. The machine divides a plurality of the instruments into a plurality of instrument pools that each includes at least one of the plurality of instruments, where the dividing is based on pre-set criteria. For each of the pools, the machine subdivides the pool into a plurality of instrument securities, each of the plurality of instrument securities representing a right to a respective one of the plurality of pools. The machine outputs, receives, and stores data for transfer of the securities between parties.

### CROSS-REFERENCE TO RELATED APPLICATIONS

This application claims priority to U.S. Provisional Patent Application No. 61/008,421, filed Dec. 19, 2007,entitled “System and Method For Trading Senior Life Settlements and their Derivatives,” which is herein incorporated by reference in its entirety.

### FIELD OF THE INVENTION

The present invention relates to a system and method for trading life insurance policies, particularly senior life settlements and their derivatives to provide liquidity and an investment vehicle to holders of life insurance policies.

### BACKGROUND INFORMATION

Some assets may have value, but lack liquidity or an immediate market for the asset. Such assets may include life insurance policies, pension annuities or settlements, retirement plans, or a hybrid of any such instruments.

In the case of life insurance, commonly known types of life insurance policies include term, whole life, variable, universal and universal variable life insurances. Under a term life insurance, the insured person pays an insurance premium to maintain the life insurance policy for a specific amount of monetary payout (“death benefit”) and over a specific period of time (“term”) for significant events, e.g., death of the insured person. If the insured person dies during the term of a term life insurance policy, the insurance company would pay the death benefit to the designated beneficiaries of the policy. However, during the life of the insured person, term life insurance policies usually do not have cash value. Other types of life insurance policies, e.g., whole life, variable, universal and universal variable life insurance, collectively referred to herein as permanent life insurance, may provide not only insurance for the life of the insured person in case the insured deceases, but also accrue a cash value during the term of the policy for the insured person. If the insured person survives the term of the permanent insurance policy, the insurance company may pay out a lump sum of the cash value to the insured person or via an annuity to the insured person. Thus, permanent life insurance policies may be called assets of values that may be transacted from one person, e.g., the insured person, to another, e.g., back to the insurance company or alternatively to a third-party purchaser.

A life settlement in this application refers to a life insurance policy that has been subjected to a financial transaction in which the owner of the permanent life insurance policy sells the permanent life insurance policy to a third party purchaser, e.g., for a value that is more than the cash value offered by the insurance company. In such a situation, the third party purchaser may become the new beneficiary to the permanent life insurance policy at its maturation and at the same time, take on the responsibility to pay all subsequent unpaid premium payments. Additionally, the third party purchaser may receive the insurance proceeds in the case that the insured person dies before the permanent insurance term runs out. In this situation, the third party purchaser may gain an amount in addition to the cash value at maturation or at the end of the life insurance term. Life settlements may provide liquidity to non-performing life insurance policy assets and allow the insured person to cash out unwanted or unneeded permanent life insurance policies before maturation. This type of liquidity may be especially important for senior life insurance policy holders. A life settlement for an insured person of 65 years or older is commonly referred to as a senior life settlement.

### SUMMARY

Although permanent life insurance policy is an asset that may have value or future economic benefit to its owner, e.g., the insured person or the insured's assignee if the insured sold the permanent life policy to a third party investor, commonly the disposal of a single permanent life insurance policy may not be easy because of its concentrated risk on a single insured person.

In the financial world, a securitization process may be employed to convert hard-to-sell assets into securities, i.e., collaterals pledged to guarantee the fulfillment of an obligation, for the purpose of facilitating a transfer of rights from one owner to another. The third party purchaser may buy the asset-backed securities for income, i.e., its above market interest rate with ascertainable risks or for the purpose of capital gains, e.g., buying in anticipation of selling the asset-backed security at a higher price. A security can take on the form of a certificate, or an electronic book entry. Today, securitization is quite common for leased properties, mortgages, home equity loans, student loans and other debts. These asset-backed securities are often traded in primary or secondary markets.

There is no known securitization method directed at assets of a collection of permanent life insurance policies. Since permanent life insurance policies, particularly senior life settlements, have the characteristics of illiquid assets with value, such securitization of senior life settlements for exchange trading may be advantageous.

Further, even with respect to sale of a single life insurance policy, the extent to which investment opportunities are provided conventionally is limited.

Example embodiments of the present invention may provide a system and method via which to securitize collections of life insurance policies, or other financial instruments or assets. A number of life insurance assets, or other financial assets, may be acquired and classified into pools according to certain criteria, e.g., the risk similarities of underlying assets, and then offered as securities or collaterals to third party purchasers or investors.

### BRIEF DESCRIPTION OF THE DRAWINGS

FIG. 1 is a diagram that illustrates a process for converting life insurance policies into Exercise Entitlements that may be traded on an electronic exchange according to one example embodiment of the present invention.

FIG. 2 is a cross-functional flowchart that illustrates a method of investing in a trust of life insurance policies or life settlements, and their derivatives according to one example embodiment of the present invention.

### DETAILED DESCRIPTION OF EXAMPLE EMBODIMENTS

According to one example embodiment of the present invention, a method of a life settlements conversion machine may include dividing by the machine a plurality of life policies into a plurality of life settlements pools that each includes at least one of the plurality of life insurance policies, where the dividing is based on pre-set criteria, and for each of the pools: subdividing by the machine the each of the pools into a plurality of life settlement securities, each of the plurality of life settlement securities representing a right to the each of the pools and outputting, receiving, and storing data for transfer of the securities between parties.

According to one example embodiment of the present invention, a security trading machine may include a hardware component including at least one electronic communication module for communicating with other security trading machine, a hardware storage component that stores data of a plurality of life settlement securities, and a processor configured for executing trades of the plurality of life settlement securities with other security trading machines according to the communications with the other security trading machines, where the life settlement securities are formed by: based on pre-set criteria, dividing a plurality of life policies into a plurality of life settlement pools that each includes at least one of the plurality of life policies, and subdividing the each of the pools into a plurality of life settlement securities, each of the plurality of life settlement security representing a right to the each of the plurality of pools.

According to one example embodiment of the present invention, a trust (“Trust”) of senior life settlements may be created in the following steps. A licensed insurance broker (“Broker”) may present prospective life insurance buyers an opportunity to purchase a permanent life insurance policy, e.g., a whole life insurance policy, from an A rated insurance carrier, e.g., AM Best. The prospective insurance buyer may be chosen in terms of a number of criteria, e.g., (i) insurance capacity of $1 million dollars or more; (ii) age over 75; and (iii) medical history of impairments. The prospective insurance buyer may be required to complete an insurance application truthfully answering all questions contained in the application regarding medical, financial and personal information. The broker may then submit the application to the broker's headquarters for a review by the underwriting department. An underwriter may review and make an evaluation of the insurance carriers with which the underwriter has a relationship and may select the insurance company (“Insurer”) for the prospective buyer. The underwriter may also be responsible for ordering Life Expectancy Rating from a rating company. If the application is accepted by the Insurer, the Insurer may send the life insurance policy along with premium schedules to the prospective insurance buyer. The buyer after reviewing with the buyer's advisors may purchase the life insurance policy, e.g., a whole life policy, by signing and remitting a first premium payment to the Insurer. Subsequently, the insured may place the policy into a Trust, e.g., a Delaware Trust, through the insured person's lawyer, making one or more persons, e.g., family members, the beneficiaries to the insurance policy, and appoint a Trustee to the Trust.

An agent (“Agent”) on behalf of a trust investor (“Trust Investor”), e.g., Sienna Capital, may make an offer to the Trustee to purchase 100% beneficiary interest in the Trust. The Trustee may accept or reject the offer. If the offer is accepted by the Trustee, the Trustee may have the insured person (“Insured”) and beneficiaries execute all necessary legal documents to assign 100% of the beneficial interest in the Trust. After due diligence by a servicer, e.g., Maple Life Settlement, to ensure the legality of documents for transferring ownership of the underlying life insurance policy, and through an escrow agency, e.g., the Wells Fargo Bank at Delaware, the Trustee may transfer the ownership of the Trust from the Trustee to the Trust Investor. The servicer, e.g., Maple Life, may track the life of the insured person. In the case of death of the insured, the Insurer may pay a death benefit to the Trust. The Trustee may then distribute the fund to the true owner of the Trust, i.e., the Trust Investor.

According to one example embodiment of the present invention, the Trust Investor may further purchase other life insurance policies (“Policies”), e.g., senior life settlements. Pools of Policies, e.g., 5 to 20 Policies per pool, may be created. Pools may be created based on criteria so that Policies within each pool may have similar characteristics, e.g., same Insurer, similar age of the Insured and terms. A master trust (“Master Trust”) may then be created for each pool of Policies, based on which derivative products may be written on the underlying asset of Policies. In an example embodiment, the derivative products may be a type of securities, called exercise entitlements (“EEs”), which are similar to warrants that may provide a purchaser of EEs with the right to a percentage, e.g., 5% of the face value (“FV”) of the Master Trust (the total FV of Policies in the Master Trust), in exchange for an obligation to pay a portion of the premiums, e.g., one year's worth of premiums, of the Master Trust. In one example embodiment, the Master Trust of a term, e.g., ten year term, may be dematerialized and subdivided into EEs of equal right, e.g., each EE worth one tenth of interest with an obligation to pay one year's premiums plus costs. In an alternative example of embodiment, an EE may correspond to a specific year during the term. In this situation, the value of an EE corresponding to a first period, e.g., year three, may vary from another EE corresponding to a second period of time, e.g., year nine because the risk of the Insured's death may be different between those two period of time. For EEs corresponding to later times may cost more than earlier years because the risk of death is commonly higher in later years due to aging. The EEs may then be assigned unique identifications, e.g., electronic digitized qualification code substantially similar to the International Security Identifying Number (“ISIN”). The EEs, as derivatives backed by the underlying asset of the Master Trust, may then be traded on an electronic exchange to potential EE investors, e.g., on the Private Trading System trading platform.

According to an alternative example embodiment of the present invention, the Trust Investor may keep a portion of the EEs derived from the Master Trust and only make the rest of EEs available for trading. A Master Trust, e.g., with FV of $1 million (for illustration purpose, assume there is only one policy within the Master Trust for one Insured) for a specific term of, e.g., ten years may have been dematerialized and subdivided into ten EEs with each EE entitled to, e.g., one year's worth of FV and obligated to pay, e.g., one year's premiums. Instead of selling all EEs via an electronic exchange, the Trust Investor may purchase a portion, e.g., 20% or two EEs for a price of, e.g., 14% of FV of $140,000, which may include two year premium payments of 8% FV or $80,000, a markup to the Insured (through a trust) of 3% FV or $30,000, an agent fee of 2% FV or $20,000, and an administrative fee of 1% FV or $10,000. The Trust Investor may then sell the rest, e.g., 80% or eight EEs to EE investors, e.g., each EE to eight EE investors. At about the same time, the Trust Investor may buy a reinsurance policy to insure 80% FV or $800k for the payout if the Insured survives, e.g., the ten year term of the Policy, at a cost of 3% FV or $30,000 to the Trust Investor. Each EE investor may pay a price including one year's premiums of, e.g., 4% FV or $40,000 plus cost to the Trust Investor, e.g., 1% FV or $10,000 for the right to one EE. In such a situation, the Trust Investor may hold two EEs for the total cost of 6% FV or $60,000, and each EE holder may hold one EE for the cost of 5% FV or $50,000.

In a situation where the Insured dies prior to the end of the Policy term, the Insurer may pay a death benefit of, e.g., $1 million to a trust created for the Insured whose Trustee may distribute the death benefit according to EE ownership, e.g., $200,000 to the Trust Investor for two EEs and $100,000 to each EE investor who owns one EE. In an alternative situation where the Insured survives, e.g., the ten year term, the reinsurance company may pay $800,000 to EE holders so that the Trust Investor may receive, e.g., $160,000 for his two EEs, and each EE investor who holds one EE may receive $80,000 for his one EE.

An alternative example embodiment of the present invention may enhance investment opportunities with respect to a single life insurance policy, e.g., not pooled together with other policies. In this situation, the Master Trust may hold only one single policy of, e.g., $1 million FV. the Trust Investor may keep a portion of the EEs derived from the Master Trust and only make the rest of EEs available for trading.

In an alternative example embodiment, the Master Trust may contain different types of insurance policies, e.g. whole life policies, variable life policies, universal life policies or universal variable life insurance policies. In yet another example embodiment of the present invention, the investment strategy may be applied to term policies, too. These listed life insurance policies may be defined according to the knowledge and understanding of a person in the art. In an alternative example embodiment, the life insurance policies within Master Trusts may be written by different insurance companies of different ratings. The terms of Policies, ages or any other features including medical, financial and credit worthiness of the Insured persons may vary. In an alternative example embodiment, an EE investor may own one or more EEs. In an alternative example embodiment, each EE may corresponds to different period of time of the Insured and may have different price or cost associated with because the risk of death associated with the Insured may vary during those time periods. In yet an alternative example embodiment, the Face Value of the life insurance policy may vary during the term of the life insurance policy because paid premiums may be invested in different forms including fixed income, equity and other types of assets for capital gains or incomes. Any gains may be distributed in the form of dividends or reinvestment in the corpus of the life insurance policy as agreed on in a contract.

In one example embodiment, the system and method of the present invention may be advantageously applied to life insurance policies for persons of at least 50 years of age, and preferably of at least 65 years of age.

In one example embodiment, the system and method of the present invention may convert life insurance policies, pension annuities or settlements, retirement plans, other insurance policies, or a hybrid of any such instrument or assets, or their derivatives, into electronic forms for trading on a private trading platform not regulated by a government and/or on an exchange as exchange-tradable securities or private tradable instruments.

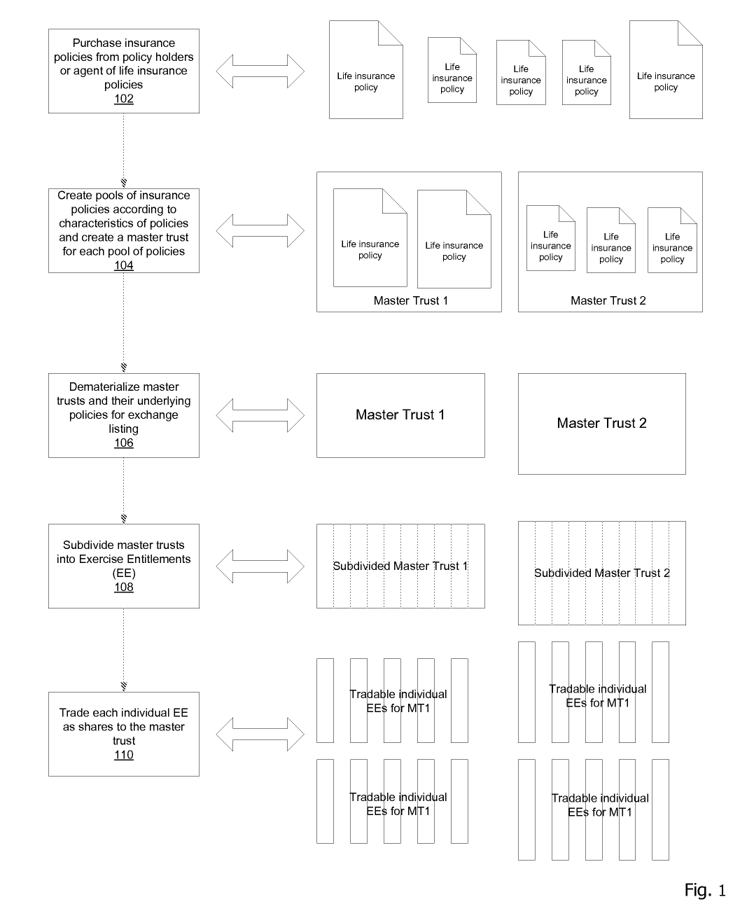

FIG. 1 is a diagram that illustrates a process for converting life insurance policies into Exercise Entitlements that may be traded on an electronic exchange according to one example embodiment of the present invention. The EEs are similar to warrants with respect to owner's right, derived from the underlying asset value of the life insurance policies, where the EEs may be traded electronically in a security exchange as life settlement securities. This process is also called dematerialization of the asset of life insurance policies.

Life insurance companies (the “Insurers”), e.g. AIG, AXA, or ING, may directly or through life insurance brokers sell permanent life insurance policies (the “Policies”), e.g., whole life, universal life or universal variable life policies to buyers (the “Insured”) who look for a life insurance with an investment component. An Insurer would write a Policy in trust to the Insured upon signing an agreement and furnishing an initial payment, e.g., first two-year premium of the Policy term, e.g., ten years. In an example embodiment, the first two-year premium may cost, e.g., 8% (4% per annum) of the payout value specified on the Policy, i.e., the Face Value of the Policy (the “FV”). With a permanent life insurance, the Insurer is liable to pay payout as a lump sum or annuity accrued from the paid premiums to the Insured if the Insured survives the term of the Policy, or to pay a death benefit of FV to the beneficiaries of the Insured if the Insured deceases before the end of the Policy term. To maintain the Policy, the Insured is responsible to pay an insurance premium each year to the Insurer.

An intermediate agent (the “Agent”) may approach the Insured to buy trusts in which the Policies reside at a price, e.g., cash value of the Policy plus 3% markup, as a life settlement, to provide the Insured with cash flow. The Insured may assign the Agent as the beneficiary in the event of the Insured death. The Agent would assume the responsibility to pay annual premium for maintaining the Policy forward. At 102, the Agent may then sell the pools of trusts to a trust investor (the “Trust Investor”) at a price that takes into consideration, e.g., the original two-year premium at, e.g., 8% of FV, the markup to the Insured at, e.g., 3% of FV, an agent fee at, e.g., 2% of FV, and an administrative fee at, e.g., 1% of FV, for a total of, e.g., 14% of FV at 102. The Trust Investor would become beneficiary of the underlying Policies, and at the same time, would assume the responsibility to pay annual premium forward to the end of the term of the underlying life insurance policy. Alternatively, at 102 the Trust Investor may buy the trusts directly from the Insured to create pools of Policies.

The Trust Investor may be a private trading company that may be interested in securitizing these discrete trusts backed by life insurance policies so that they can be traded on an electronic exchange, or may be a private investing company that may be interested in investing in securitized life insurance policies. To these ends, at 104, a series of pools of trusts of Policies may be created, each of which may include policies in trusts that have similar characteristics, e.g., same Insurer, similar age profile of the Insured and/or similar maturity, i.e., life expectancy, of the Insured. Each pool of similar policies may be placed into a Master Trust to create a series of Master Trusts. The Master Trust and their underlying assets may be dematerialized in preparing for listing and trading on an electronic exchange, at 106. Alternatively, step 106 may be performed prior to step 104.

The dematerialization process may begin with the Trust Investor recording the data of each underlying Policy in an electronic register. At step 1, this may require the listing of the specificities of documentary aspects that make up the due-diligence package of each life insurance policy involved. At step 2, the format of the above listing may be adapted to conform with the formalities that are required, e.g., to classify the listing as a security or asset with transferability. At step 3, legal provisions and standardized clauses, for acceptability to the nominated central clearing system utilized (even accepting that it is transferable satisfactorily to all), may also be provided in writing for creating an International Security Identifying Number (“ISIN”). Then, the created security may be accepted electronically by all central clearing systems worldwide. The legal provisions and standardized clauses may be related to convertibility, redemption on demand, specific terms and conditions of transfer, transferability both from agents and holders proviso wise, exact and specific legal entitlements and descriptions within the document (e.g., what exactly a unit of a Policy, e.g., a Senior Life Settlement unit (“SLSU”), and its corresponding EE represents), details of any agency criteria (whether they are normative or not), value both nominal and denominative (how the translatable instrument is reflected by value of both face value and its derivative thereof), pricing (reflected specifically or as a spread or percentage of nominate value and clearly defined on each unit or package of units presented), definitive description of credit/issuer and legal provisions, e.g., description or liability issues (whether waived or not, according to standardized issuance documents as are required by disclosure regulations), an acceptable depository or transfer agent with access to the same (who may nominated to accept physical possession and delivery of all relevant documentation that makes up the basis for dematerialization according to above steps 1 and 2), allocation of electronic digitized qualification code (e.g. ISIN).

The Master Trusts may then be subdivided into individual units with each of the units possessing an equal interest in the underlying Master Trust and, therefore, the collection of Policies residing in trusts and within the pool that makes up the Master Trust at 108. In one example embodiment, a unit of the subdivided Master Trust may be, e.g., the right to one year's worth of the FV for a pool of Senior Life Settlements with unified terms of ten years which have been subdivided into ten equal units. In an alternative embodiment, a unit of the subdivided Master Trust may represent an amount of interest to the whole Master Trust, e.g., 10% interest in a Master Trust that is subdivided to ten equal parts. Each unit may then be allocated with an individual identifying serial number (which may be equivalent to a CIN, ISIN, SEDOL (Stock Exchange Daily Official List), or CUSIP (Committee on Uniform Security Identification Procedures) number) and be recorded electronically in the register. All information may be made available to prospective investors or purchasers of units to the Master Trust electronically.

At 110, the units of the subdivided Master Trust, or EE, may then be traded electronically as they may have been converted into electronic form that is suitable for trading. The EEs may be traded on an electronic trading platform, e.g., Private Trading Systems trading platform or any other global electronic trading platforms. The buyers or the owners of individual EEs may be recorded in an electronic register, in a sense equivalent to a stockholder register. Each EE holder may have a clear right to the value of the pool to which the EE belongs and, when the Insured dies, the funds paid by the Insurer to the trustee in which the Policy resides. The system and method may allocate returns to record investors and produce output indicating such returns. Further, the system and method may communicate with machines operated by or of financial institutions for transferring and reallocation of funds between parties according to the calculated returns.

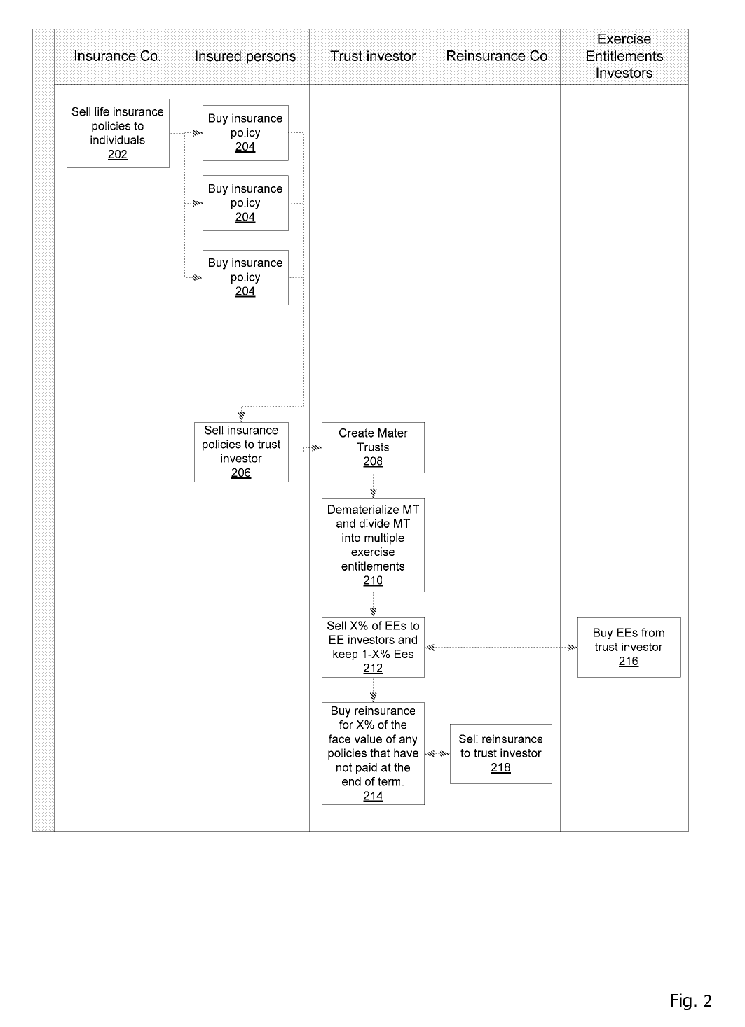

FIG. 2 is a cross-functional flowchart that further illustrates a method of investing in a trust of life insurance policies or life settlements, and their derivatives according to one example embodiment of the present invention. FIG. 2 illustrates a process in which the Trust Investor, instead of merely acting as a trader of EEs, invests in units of the Master Trust to achieve a gain. As previously described, the Insurer, at 202, either through insurance brokers or directly, may sell Policies to the Insured in trust. The Insured may buy a Policy for the benefit of beneficiaries in case of death or for capital appreciation if the Insured survives the term of the Policy at 204. The Trust Investor may, through an agent or directly, purchase pools of life insurance policies from the Insured at 206 to create Master Trusts, each of which holds trusts of Policies that have similar characteristics, e.g., from the same Insurer with similar terms and age profiles of the Insured 208. As previously described, at 210, the Master Trust may be dematerialized and subdivided into a series of EEs that may be traded on an electronic exchange, e.g., the Private Trading System trading platform.

For a pool of Master Trusts that have been subdivided into Senior Life Settlement units or EEs, e.g., 10 EEs for a term of ten year, the Trust Investor may sell a portion of the EEs, e.g., 80% of EEs to EE investors and keep the rest, e.g., 20% of the EEs at 212. After the selling of EEs to EE investors, the Trust Investor may buy a reinsurance policy written on the pool of Policies to guarantee a payout of 80% of the Face Value of any of the Policies which have not been paid out by the Insurer at the end of the term at 214. The EEs may be sold to EE investors in such a way that the price of EEs would be sufficient to cover the two year premium and/or original costs to create the Master Trust so that the Trust Investor would have a residual interest in the value of the Master Trust for an effective zero cost,—by recovering his initial expenses from the sale of EEs. In addition, each EE holder may be liable for his portion, e.g., one year worth of premium payment. Under such an arrangement, the Trust Investor may be guaranteed a pay out at the end of the Policy term, e.g., 10 years.

Those skilled in the art can appreciate from the foregoing description that the present invention may be implemented in a variety of forms, including, for example, variations of the sequence of the steps shown in FIGS. 1 and 2, and that the various embodiments may be implemented alone or in combination. Further, although examples are provided for life settlements, it is understood that the system and method of the present invention may be applied to instruments including but not limited to pension annuities or settlements, retirement plans, other insurance policies, or a hybrid of any such instrument or assets. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A method of a life settlement conversion machine, comprising:
dividing, by the machine, a plurality of life insurance policies into a plurality of life settlement pools that each includes at least one of the plurality of life insurance policies, wherein the dividing is based on pre-set criteria;
for each of the plurality of life settlement pools, subdividing, by the machine, the pool into a plurality of life settlement securities, wherein each of the plurality of life settlement securities represents a right to a respective one of the pools; and
outputting, receiving, and storing data for transfer of the securities between parties.

2. The method of claim 1, wherein the plurality of life settlements include only life insurance policies for persons of at least 50 years of age.

3. The method of claim 2, wherein the plurality of life settlements include only life insurance policies for persons of at least 65 years of age.

4. The method of claim 1, wherein the pre-set criteria include at least one of an age of an insured person and a life expectancy of an insured person.

5. The method of claim 1, wherein each of the plurality of life settlements in each of the plurality of life settlement pools is converted and recorded in an electronic register.

6. The method of claim 1, wherein each of the life settlement securities represents a right to a percentage of a combined face value of those of the life settlements that underlie the respective life settlement pool out of which the life settlement security has been subdivided.

7. The method of claim 6, wherein the percentage is a ratio of a number of the life settlement securities into which the trust has been subdivided to the combined face value.

8. The method of claim 1, wherein each of the life settlement securities represents a right to a payout of a combined face value of a sub-time-period of those of the life settlements that underlies the respective life settlement pool out of which the life settlement security has been subdivided.

9. The method of claim 1, wherein each of the plurality of life settlement securities is assigned a unique identification.

10. The method of claim 9, wherein the identification is one of an ISIN, a CIN, a SEDOL, and a CUSIP number.

11. The method of claim 1, wherein each of the plurality of life settlements has a term of time during which an event of significance must occur for a payout.

12. The method of claim 11, wherein the term is ten years.

13. The method of claim 1, wherein:
the transfer includes selling a percentage of the life settlement securities to an investor; and
a reinsurance policy is purchased for a percentage of a face value of the pool that is not paid at an end of a term of the life settlements.

14. A security trading system, comprising:
a hardware component including at least one electronic communication module for communicating with other security trading machines;
a hardware storage component that stores data of a plurality of life settlement securities; and
a processor configured for executing trades of the plurality of life settlement securities with other security trading machines according to the communications with the other security trading machines,
wherein the life settlement securities are formed by:
based on pre-set criteria, dividing a plurality of life policies into a plurality of life settlement pools that each includes at least one of the plurality of life policies;
dematerializing each of the plurality of life settlement pools; and
subdividing each of the pools into a plurality of life settlement securities, each of the plurality of life settlement securities representing a right to a respective one of the plurality of pools.

15. The method of claim 14, wherein each of the life settlement securities represents a right to a percentage of a combined face value of those of the life settlements that underlie the respective life settlement pool out of which the life settlement security has been subdivided.

16. The method of claim 14, wherein each of the life settlement securities represents a right to a payout of a combined face value of a sub-time-period of those of the life settlements that underlie the respective life settlement pool out of which the life settlement security has been subdivided.

17. The method of claim 16, wherein each of the plurality of life settlements has a term of time during which an event of significance must occur for a payout, the sub-time period being less than the time of the term.

18. A method of an asset conversion machine, comprising:
dividing, by the machine, a plurality of assets into a plurality of instrument pools that each includes at least one of the plurality of instruments, wherein the dividing is based on pre-set criteria; and
for each of the plurality of life settlement pools:
storing data for a trust formed for the pool, including data of a trust investor to whom the trust is transacted;
subdividing, by the machine, the trust into a plurality of life settlement securities, wherein each of the plurality of life settlement securities represents a right to a respective one of the trusts; and
outputting, receiving, and storing data for transfer of the securities between parties;
wherein rights of the parties arising from ownership of the securities differ from rights of the trust investor.

19. The method of claim 18, wherein the assets are one of pension annuities, pension settlements, retirement plans, and a hybrid of at least one of a pension annuities, pension settlements, and retirement plans.

20. A hardware-implemented computer-readable medium having stored thereon instructions, the instructions, when executed, causing a processor to perform a life settlement conversion method, the method comprising:
dividing, by the machine, a plurality of life insurance policies into a plurality of life settlement pools that each includes at least one of the plurality of life insurance policies, wherein the dividing is based on pre-set criteria;
for each of the plurality of life settlement pools, subdividing, by the machine, the pool into a plurality of life settlement securities, wherein each of the plurality of life settlement securities represents a right to a respective one of the plurality of pools; and
outputting, receiving, and storing data for transfer of the securities between parties.

21. A method of a life settlement conversion machine, comprising:
for each of a plurality of life settlement pools into which a plurality of life insurance policies are divided such that each pool includes at least one of the policies, subdividing, by the machine, the pool into a plurality of life settlement securities, wherein each of the securities represents a right to a respective one of the pools; and
outputting, receiving, and storing data for transfer of the securities between parties.
